(19) United States
(12) Patent Application Publication
(10) Pub. No.: US 2008/0223419 A1
(43) Pub. Date: Sep. 18, 2008

(54) Portable stain removing instrument from a dry-cleaned laundry

(76) Inventor: Bong Ha Chun, Lawrenceville, NJ (US)

Correspondence Address: Bong Ha Chun, 94 Traditions Way, Lawrenceville, NJ, 08648, US

(21) Appl. No.: 11/724,672

(22) Filed: Mar. 16, 2007

(51) Int. Cl. B08B 5/04

(52) U.S. Cl. 134/104.2

(57) ABSTRACT

A portable stain removing instrument from a laundry is provided. The stain removing instrument of the current application is to remove stains from a laundry after cleaning. The stain removing instrument is comprised of a head set, which has pluralities of small holes developed on the upper surface of an upper frame that is supported by a lower supporting frame and a separator. The separator is connected to the stain removing instrument's head set and a vacuum line via a special “T” connector. The upper frame of the stain removing instrument has the shape of an ironing board. One end of the head is shaped in a rounded “V” and the other end is flat. There is a void space inside the stain remover space. Air flows through small holes at the stain removing head, through the void space, and goes to a vacuum pump, which is connected to the stain remover head. Stain particles and solvents are separated and collected by the separator.

### FIELD OF THE INVENTION

The current application is related to a stain removing instrument, especially designed to remove stains from dry-cleaned laundry.

### BACKGROUND OF THE INVENTION

In the laundry business dry-cleaning require a lot of money to operate. Dress suits, high-value silk wear, and most women outer wear should be dry-cleaned. However, dry-cleaning require special machines and large amounts of space to install and operate. Most dry-cleaners have their own plant outside the cities.

If a customer visits a laundry shop near their home the laundry shop does not dry-clean the laundry in the spot. The shop collects the items from the customer and hand them over to the dry-cleaning plant. Usually the customer points out the stained parts of the laundry and requests the laundry shop to mark the respective stains to the dry-cleaning plant.

But, if the marks are removed from the clothing items the dry-cleaning plant operator would not be able to remove the stain. The laundry shop cannot check the cleaning status until the clothes are returned to the shop from the plant. Therefore if no stain is removed, then the customer does not pay the laundry shop for the service.

The purpose of the current application is to provide a portable stain removing instrument that can be installed in a small space of the laundry shop and remove stains without the need to send the laundry to the dry-cleaning plant.

### DESCRIPTION OF THE PRIOR ART

U.S. Pat. No. 6,080,243, to Insley, et al. illustrates a fluid guide device that can evenly and effectively distribute the potential; from a fluid transport source over an area substantially larger than the opening of the source conduit. The fluid guide device includes—a first major surface having a structured surface with a minimum aspect ratio of 10 to 1, a hydraulic radius no greater than about 300 microns (.um).

The fluid guide device also includes an active fluid transport source external to the structured polymeric surface to provide a potential over the flow channels and promote movement of matter through the flow channels from a first potential to a second potential. The fluid transport source is connected with a plurality of flow channels of the structured surface by way of a manifold.

U.S. Pat. No. 6,513,192, to Pearlstein, illustrates a vacuum nozzle or suction head for efficiently and effectively removing any standing liquid from fabric surfaces such as carpets. The nozzle is formed by a nozzle body defining an internal enclosed vacuum chamber and an upper vacuum source port opening into the chamber.

A sleeve adapted to receive a vacuum source tube is affixed to the nozzle body and opens into the port. The nozzle body has a bottom plate defining an outer bottom surface with a plurality of vacuum suction ports opening into the chamber and an outer enlarged portion opening into the surface. None of the Prior Act illustrates an effective stain remover from the laundry in a small space in a laundry shop.

### SUMMARY OF THE INVENTION

Dry-cleaning requires a lot of money to operate. High-value clothing items should be dry-cleaned. Dry-cleaning operation require large spaces and special machines. Laundry shops near residential areas do not offer dry-cleaning service because of the require space to accommodate such machines. Instead they collect the laundry items from the customer and send them over to dry-cleaning plants located outside cities. The laundry shop cannot check cleaning status until the items are returned from the plant to the shop. If the some stains are not fully removed, then the customer does not pay for the service.

The purpose of this current application is to provide a portable stain removing instrument that can be installed in a relatively small space in the laundry shop. A portable stain removing device is to remove any unmarked stains from the clothes after it arrives back from the dry-cleaning plant. Thus this new invention helps reduce or eliminate any unsatisfactory service from the unmarked stains.

The stain removing instrument consists of—a head, which has pluralities of small holes located at the upper surface, a—separator the separator, connected to the stain removing head and a vacuum line via a “T” connection. The head of the stain removing instrument is shaped like an ironing board. One end with shaped like a rounded “V” and the other end being flat. The stain removing head has a void space. Small holes pass through and on the other side there is a vacuum pump that is connected to the stain remover head. Solvents and solids from the stain are separated and collected by a separator.

### BRIEF DESCRIPTION OF THE DRAWINGS

FIG. 1 is a perspective view of the portable stain removing instrument according to the current application.

FIG. 2 is an exploded view of the portable stain removing instrument according to the current application.

FIG. 3 is a cross sectional view of a special “T” connection for the portable stain removing instrument according to the current application.

FIG. 4 is an overview of the special “T” section viewed from the “A” point of view of FIG. 3.

FIG. 5 is a schematic cross sectional view illustrating how to remove stains from a dry-cleaning shop utilizing a portable stain removing instrument according to the current application.

### DETAILED DESCRIPTION OF THE PREFERRED EMBODIMENT

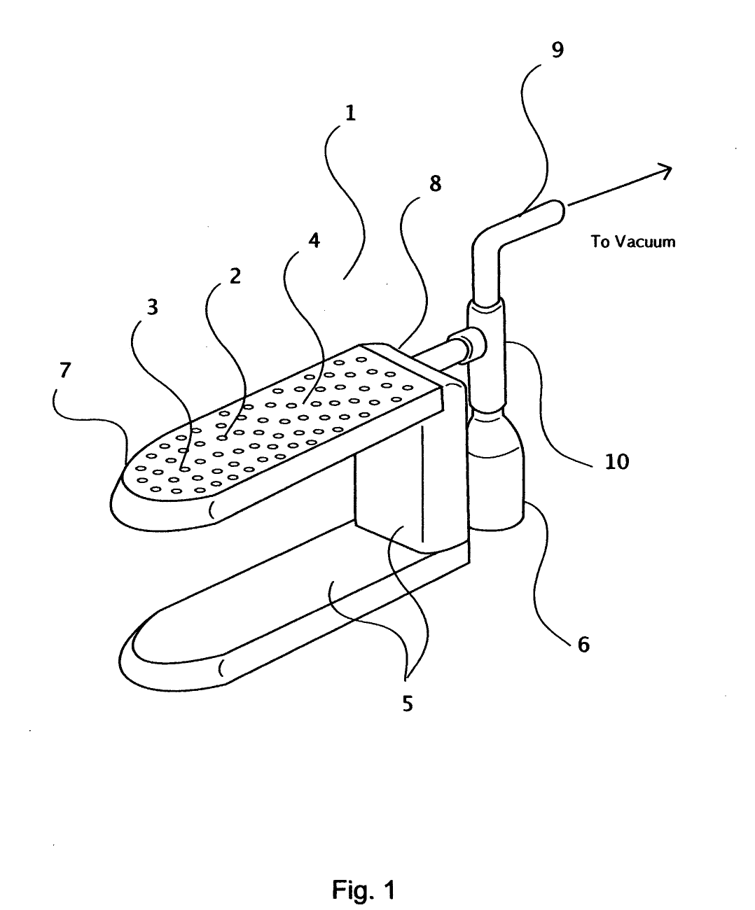

FIG. 1 is a perspective view of a portable stain removing instrument (1) according to current application. The portable stain removing instrument (1) is comprised of a head set (2), which has pluralities of small holes (3) developed on the upper surface (4-U) of an upper frame (4) that is supported by a lower supporting frame (5), and a separator (6). The upper frame (4) of the stain removing instrument (1) is in a shape of an ironing board. One end (7) of the head is shaped in a rounded “V” and the other end is flat (8). The shape enables the upper frame (4) of the instrument (1) reach the narrow corner of a laundry, inside of an arm sleeve of the laundry.

The separator (6) is connected to the other end (8) of the upper frame (4) of the stain removing instrument (1) and to a vacuum line (9) via a special “T” connector (10). A slight vacuum is applied to this instrument, lower than 730 millimeters of mercury.

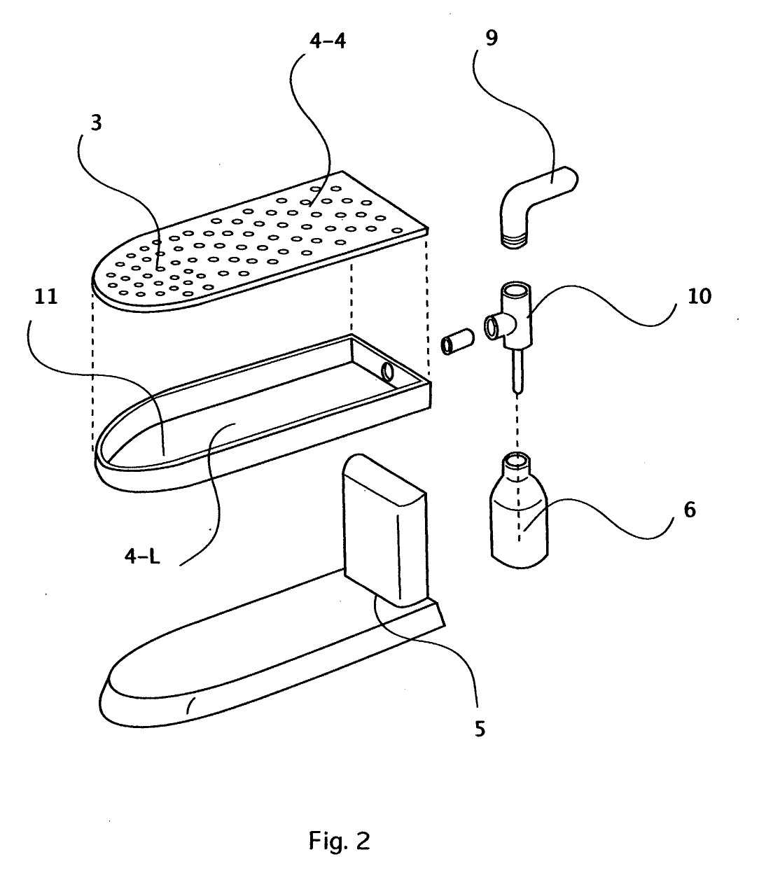

FIG. 2 is an exploded view of a portable stain removing instrument (1) according to current application. Inside of the upper frame is a void space (11). Air flows into the void space (11) of the head through the small holes (3), pass through the void space (11) and goes out to a vacuum pump (not shown in the Figures) that is connected to the stain removing head set (2).

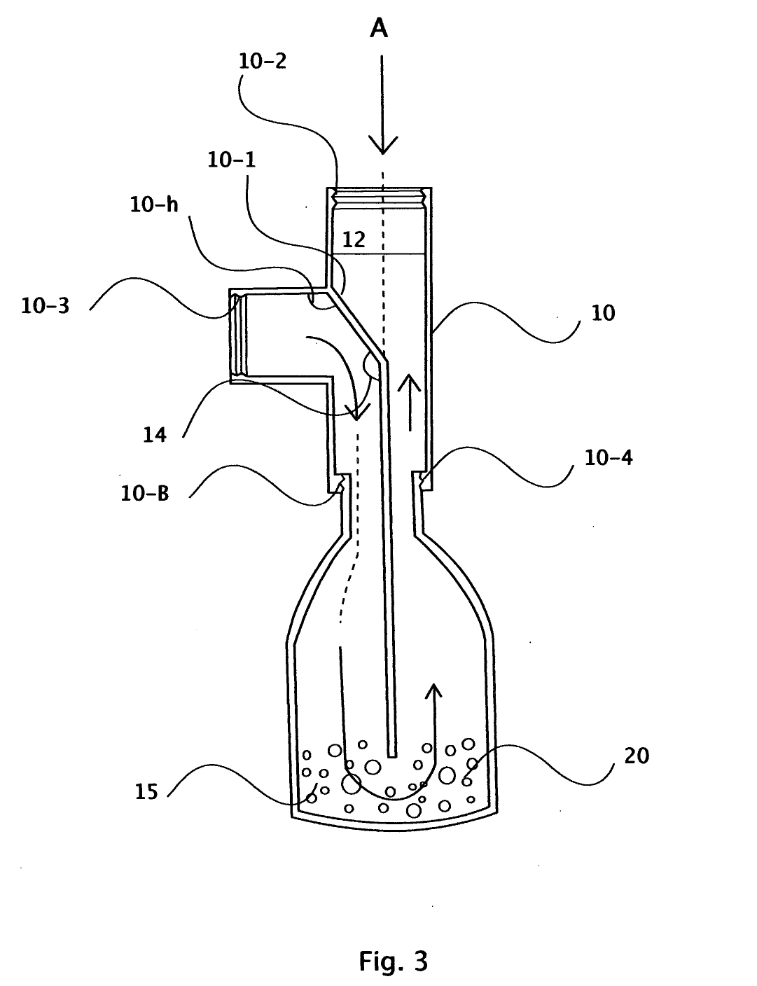

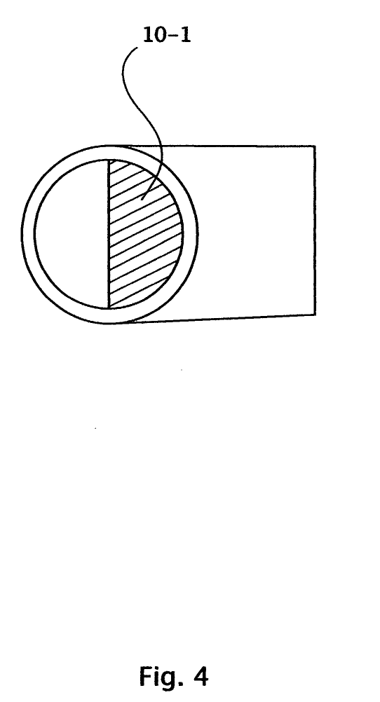

Solvents and solid particles from stains are separated and collected by a separator. FIG. 3 is a cross sectional view of a special “T” connector (10) for the portable stain removing instrument (1) and FIG. 4 is an overview of the special “T” connector seen the viewpoint “A” in FIG. 3.

The special “T” connector (10) has a long separating baffle (10-1) that is placed inside of the connector (10). The separating baffle (10-1) is made of the same material, white Polyvinyl Chloride (PVC) for example, that constitutes the connector (10). The separating baffle (10-1) starts from the upper junction point (10-U). The baffle (10-1) extends to the center of the inner diameter (12) of he connector (10) with an angle (13) of 135 degrees (14) downward parallel to the wall of the connector (10). The separating plate (10) makes a one way channel that is pen only to the bottom end (10-B) of the connector (10). The separating baffle (10-1) extends further and reaches out of the bottom end (10-B) of the connector (10). Lower tip (15) of the separating baffle (10-1) comes 5 centimeters out of the bottom end (10-B) of the connector. When the separator (6) is connected to the special “T” connector, the lower tip (15) of the separating baffle (10-1) reaches 5 centimeters to 10 centimeters inside from the opening of the separator (6). The view over the connector (10) shows that the separating baffle (10-1) blocks half of the inner column of the connector.

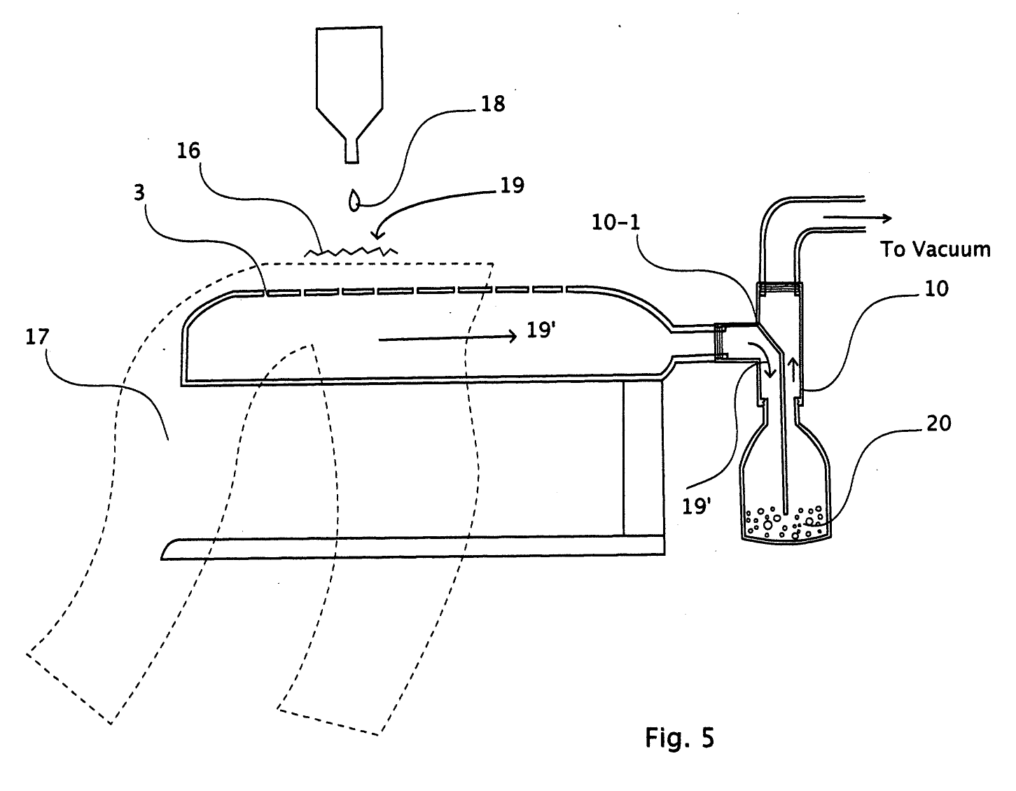

FIG. 5 is a schematic cross sectional view illustrating how to remove stains (16) from a dry-cleaning laundry (17) utilizing a portable stain removing instrument (1) according to current application.

When a laundry shop owner finds some remaining un-removed stains (16) on the shoulder of a dry-cleaned laundry (17) on the small holes (3) of the upper frame (4) of the stain removing instrument (1) of current application. Place the stained part of the laundry (17) on the small holes (3) of the upper frame (4) of the instrument (1). Spray a chemical stain remover (18) on the stain (16) and scrub to dissolve the stain. After that turn on the vacuum pump (not shown in the Figures).

Due to the suction power of the vacuum; air (19) pass through the stain (16), dissolved by the stain remover (18), and carries both dissolved stain (16) and stain remover (18) out. The stain (16) dissolved in the stain remover (18) is entrained in the air (19) and pass though the small holes (3). Air stream (19′), which contains the dissolved stain (16) in the stain remover (18), pass through the void space (11) inside of the upper frame of the stain removing instrument (1) and reaches a special “T” connector (10). When the air stream (19′) reaches inside of the special “T” connector (10), the separating baffle (10-1) blocks the air stream (19′) and turns the direction of the stream downward. The air stream (19′) reaches the bottom of the separator (6). At the bottom of the separator (6) Zeolites (Molecular Sieve 13A) are packed to absorb and separate the chemical stain remover (18) and stains from the air (19).

What is claimed is;

1. A portable stain removing instrument comprised of;
a head set, which has pluralities of small holes developed on the upper surface of an upper frame that is in a shape of an ironing board, one end of the head is shaped in a rounded “V” and the other end is flat, and has a void space therein to allow air flows into the void space of the head through the small holes, pass through the void space and goes out to a vacuum pump that is connected to the head set and is supported by a lower supporting frame, and
a special “T” connector, which has a long separating baffle that is placed inside thereof starts from the upper junction point and extends to the center of the inner diameter of he connector with an angle of 135 degrees downward parallel to the wall of the connector to make a one way channel that is pen only to the bottom end of the connector and extends further and reaches out of the bottom end of the connector and
a separator one end of which is connected to the other end of the upper frame of the stain removing instrument and the other is connected to a vacuum line via the special “T” connector to apply a slight vacuum of 730 millimeters of mercury to the stain removing instrument and collect and separate solvents and particles.

2. A portable stain removing instrument of claim 1, wherein lower tip of the separating baffle comes 5 centimeters out of the bottom end of the connector.

3. A portable stain removing instrument of claim 1, wherein the lower tip of the separating baffle reaches 5 centimeters to 10 centimeters inside from the opening of the separator when the separator is connected to the special “T” connector.
